(19) United States
(12) Patent Application Publication
(10) Pub. No.: US 2026/0037559 A1
(43) Pub. Date: Feb. 5, 2026

(54) USING CROWDSOURCED REINFORCEMENT LEARNING TO OPTIMIZE A NATURAL LANGUAGE INTERFACE SYSTEM

(71) Applicant: Cisco Technology, Inc., San Jose, CA (US)

(72) Inventors: Timothy Simon Stirling, Gilly (CH); Yannick Weibel, Cugy (CH); Sofia Karygianni, Dübendorf (CH)

(73) Assignee: Cisco Technology, Inc., San Jose, CA (US)

(21) Appl. No.: 18/791,246

(22) Filed: Jul. 31, 2024

(51) Int. Cl. G06F 16/33; G06F 16/2455; G06F 16/383

(52) U.S. Cl. CPC G06F 16/3344; G06F 16/2456; G06F 16/383

(57) ABSTRACT

In one implementation, a device receives a query from a user for input to a large language model. The device matches a pattern associated with the query with one or more prior chat exchanges between the large language model and one or more other users. The device generates an adjusted query based on the query and the one or more prior chat exchanges. The device provides an answer to the adjusted query from the large language model to the user.

### TECHNICAL FIELD

The present disclosure relates generally to using crowdsourced reinforcement learning to optimize inputs to a natural language interface (NLI) system.

### BACKGROUND

The recent breakthroughs in large language models (LLMs), such as ChatGPT and GPT-4, represent new opportunities across a wide spectrum of industries. More specifically, the ability of these models to follow instructions now allow for interactions with tools (also called plugins) that are able to perform tasks such as searching the web, executing code, etc. In addition, agents can be written to perform tasks by chaining multiple calls to one or more LLMs. For example, a first step can consist in formulating a plan in natural language, and subsequent steps in executing on this plan by writing code to call application programming interfaces (APIs) or libraries.

In the context of monitoring computer networks, these technologies could allow for the development of a natural language interface (NLI) system that can aid an administrator in performing their administrative task. For instance, rather than forcing the administrator to navigate through complex menus to find certain information, the NLI system could simply allow the administrator to issue the query, “what is the AP with the most clients?”

Users frequently interact with NLI systems in an iterative answer, adapting or extending questions based on responses until they retrieve the desired result. However, these exchanges are often sub-optimal, as many users do not know how to phrase their questions in a way to elicit their desired answers. For instance, the query “what is the radio with the highest power?” is ambiguous as ‘power’ may refer to the electrical power of the radio or to its transmit power.

### BRIEF DESCRIPTION OF THE DRAWINGS

The implementations herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example architecture for using crowdsourced reinforcement learning to optimize inputs to a natural language interface (NLI) system;

FIG. 4 illustrates an example of the interactions of the components of the architecture in FIG. 3; and

FIG. 5 illustrates an example simplified procedure for using crowdsourced reinforcement learning optimize inputs to an NLI system.

### DESCRIPTION OF EXAMPLE IMPLEMENTATIONS

### Overview

According to one or more implementations of the disclosure, a device receives a query from a user for input to a large language model. The device matches a pattern associated with the query with one or more prior chat exchanges between the large language model and one or more other users. The device generates an adjusted query based on the query and the one or more prior chat exchanges. The device provides an answer to the adjusted query from the large language model to the user.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

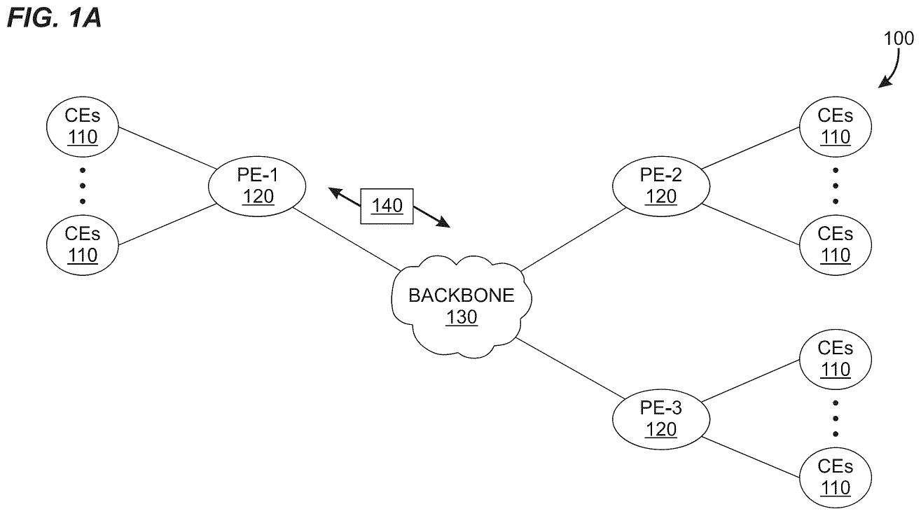

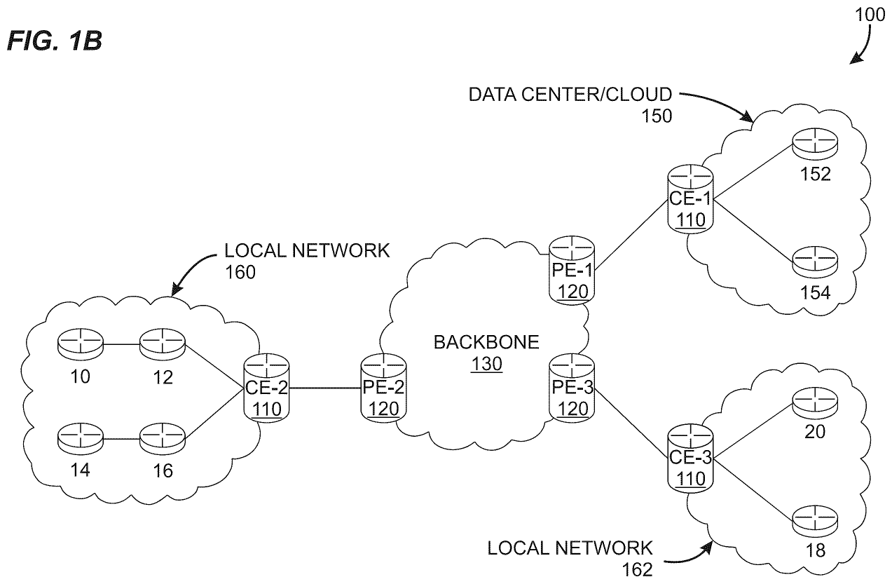

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network by the CE router via two primary links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various implementations. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

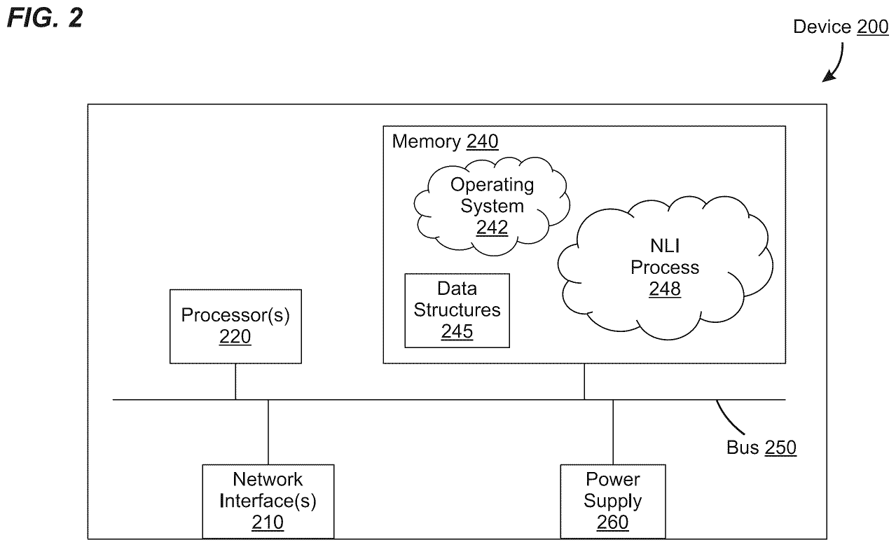

FIG. 2 is a schematic block diagram of an example node/device 200 (e.g., an apparatus) that may be used with one or more implementations described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250 and powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software components may comprise an NLI process 248 as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, NLI process 248 may include computer executable instructions that, when executed by processor(s) 220, cause device 200 to perform the techniques described herein. To do so, in some implementations, NLI process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, NLI process 248 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that NLI process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, NLI process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, generative adversarial networks (GANs), large language models (LLMs), other transformer models, and the like.

As noted above, the recent breakthroughs in LLMs, such as ChatGPT and GPT-4, represent new opportunities across a wide spectrum of industries. More specifically, the ability of these models to follow instructions now allow for interactions with tools (also called plugins) that are able to perform tasks such as searching the web, executing code, etc.

In the specific context of computer networks, though, network troubleshooting and monitoring are traditionally complex tasks that rely on engineers analyzing telemetry data, configurations, logs, and events across a diverse array of network devices encompassing access points, firewalls, routers, and switches managed by various types of network controllers (e.g., SD-WAN, DNAC, ACI, etc.). Moreover, network issues can manifest in various forms, stemming from a multitude of factors, each with its own level of complexity.

The introduction of plugins is a major development that enables LLM-based agents to interact with external systems and empower new domain-specific use cases. In the context of communication networks, the utilization of plugins allows LLMs to engage with documentation repositories, tap into knowledge bases, and interface with live network controllers and devices potentially opening the path to LLMs undertaking more complex tasks such as on-demand troubleshooting, device configuration, and performance monitoring. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

In the context of monitoring computer networks, these technologies could allow for the development of a natural language interface (NLI) system that can aid an administrator in performing their administrative task. For instance, rather than forcing the administrator to navigate through complex menus to find certain information, the NLI system could simply allow the administrator to issue the query, “what is the AP with the most clients?”

Users frequently interact with an NLI system in an iterative manner, adapting or extending questions based on responses until they retrieve the desired result. They often do not know the best way to phrase their question or the best series of questions to achieve their goal and that can be time-consuming, frustrating, and challenging at times. This flow of user interactions with the NLI contains valuable information that can be leveraged to improve the experience of future user interactions.

For example, consider the case in which an NLI is configured to provide information about the operations of a wireless network (e.g., through execution of NLI process 248). In such a case, a user of the NLI system may ask: “What is the radio with the highest power?” However, the term ‘power’ might be ambiguous and refer to either the electrical power consumed by the radio or to the transmit power of the radio. In such a scenario, the NLI might assume electrical power and return results to the user that are irrelevant to their interests. In such a case, the user may subsequently ask: “What is the radio with the highest transmit power?”

One observation herein is that the iterative chat interactions between users and an NLI whereby a user issues a series of questions until the system returns a satisfactory answer can provide valuable information for purposes of optimizing future interactions between users and the NLI.

### Using Crowdsourced Reinforcement Learning to Optimize Inputs an NLI System

The techniques herein leverage reinforcement learning to optimize the inputs to an NLI system based on crowdsourced interactions with the system. In various aspects, the techniques herein provide for an NLI system and workflow that leverages crowdsourced information from prior user interactions to reduce the expected number of iterations and, thereby, improving user experience. More specifically, the NLI system may learn from the adaptation of questions in the prior interactions and automatically adjust the query of a user to elicit an answer that is more likely to align with the intent of the user. Doing so can help optimize the interaction between the user and the NLI system by reducing the number of steps needed to arrive at a satisfactory answer and improving the experience of the user.

Illustratively, the techniques described herein may be performed by hardware, software, and/or firmware, such as in accordance with NLI process 248, which may include computer executable instructions executed by the processor 220 (or independent processor of interfaces 210) to perform functions relating to the techniques described herein.

Specifically, in various implementations, a device receives a query from a user for input to a large language model. The device matches a pattern associated with the query with one or more prior chat exchanges between the large language model and one or more other users. The device generates an adjusted query based on the query and the one or more prior chat exchanges. The device provides an answer to the adjusted query from the large language model to the user.

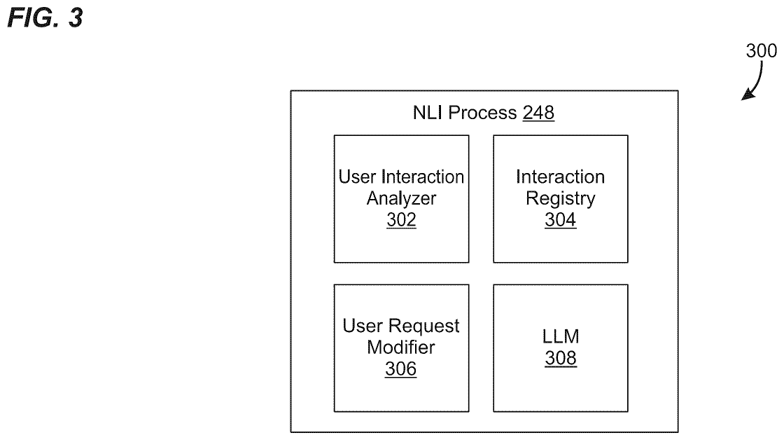

Operationally, FIG. 3 illustrates an example architecture for using crowdsourced reinforcement learning to optimize inputs to an NLI system. At the core of architecture 300 is NLI process 248, which may be executed by a controller for a network, a networking device (e.g., a router, gateway, switch, etc.), an endpoint, a server, or the like.

As shown, NLI process 248 may include any or all of the following components: user interaction analyzer 302, an interaction registry 304, a user request modifier 306, and/or a language model, such as LLM 308. As would be appreciated, the functionalities of these components may be combined or omitted, as desired. In addition, these components may be implemented on a singular device or in a distributed manner, in which case the combination of executing devices can be viewed as their own singular device for purposes of executing NLI process 248. For instance, in some cases, LLM 308 may be integrated directly into NLI process 248 whereas, in other cases, NLI process 248 may access LLM 308 remotely via an application programming interface (API).

In various implementations, the techniques herein collect and analyze the chat interactions of multiple users with the NLI system, to extract communication and interaction patterns that are domain relevant. This provides several possibilities to improve user experience and system performance. Firstly, this permits additional fine-tuning of the ML model in the NLI system to recognize and address user queries more accurately, with adaptations fine-tuned to current trends in user requests. Secondly, the interaction patterns can be used to automatically adapt user's request prompts before submitting to the ML model. Thirdly, it would also facilitate the system in providing example proposals of more pertinent prompts to users in future sessions, especially if the system is not confident in automatically modulating the initial user request.

During execution, user interaction analyzer 302 may be responsible for capturing information regarding interactions between users and the NLI system and, typically, with LLM 308. In turn, user interaction analyzer 302 may store this information in interaction registry 304.

In one implementation, user interaction analyzer 302 may divide each chat session into multiple tasks where each task signifies the part of the session where the user was pursuing the same goal, e.g., retrieve information about a particular network entity. In such a case, user interaction analyzer 302 may assign a title and/or short description to each task, along with metrics about how successful the interaction was. These success metrics could be based on factors such as the number of questions asked, the semantic similarity of the subsequent questions, combinations thereof, or the like. User interaction analyzer 302 may also group the tasks into categories based upon the similarity of their underlying goals. One implementation of this could be based on distance-based clustering on the embeddings of the tasks' titles and descriptions. Finally, for each goal category, user interaction analyzer 302 may identify the task execution with the best metrics and store this into interaction registry 304 as an optimal interaction pattern that would drive the user to their intended goal faster. Alternatively, user interaction analyzer 302 could post-process the task pattern to get an even better representation pattern by merging questions that have high semantic overlap.

According to various implementations, user request modifier 306 may utilize the optimal interactions in interaction registry 304 to adjust a new user query for LLM 308 so that it returns the final, desired result even when encountered with any of the incomplete or ambiguous, intermediate questions in the patterns. In another instance, this could be achieved by fine tuning LLM 308 on the patterns stored in user request modifier 306 and the targeted responses. In another implementation, user request modifier 306 may present any suggested modifications to a query back to the user for approval. In other cases, user request modifier 306 may simply submit the adjusted query to LLM 308.

In general, the adjusted query may be based on the optimal chat interaction patterns stored in user request modifier 306 for the relevant task(s). To do so, user request modifier 306 may use any form of suitable machine learning technique for text classification. For instance, if the pattern of the incoming query matches that of prior queries that request the same or similar tasks, user request modifier 306 may use the information in user request modifier 306 regarding those prior interactions to adjust the new query, accordingly.

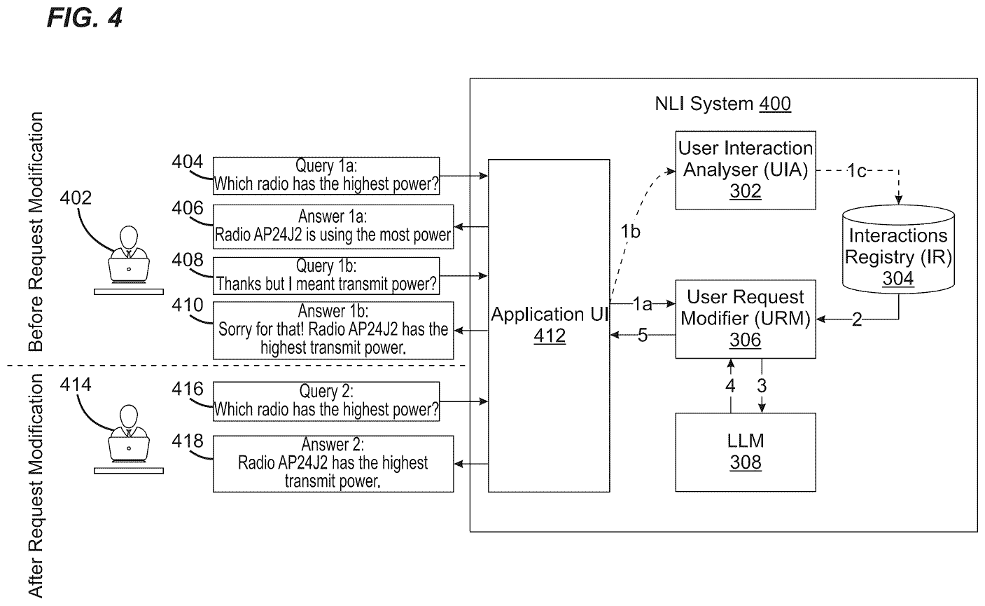

FIG. 4 illustrates an example of the interactions of the components of the architecture in FIG. 3 to implement an NLI system 400. As shown, NLI process 248 may be operable to provide an application user interface (UI) 412 to any number of users, such as user 402 and user 414. Initially, assume that NLI system 400 does not have sufficient information for user request modifier 306 to provide any useful modifications to any incoming queries, meaning that NLI system 400 may provide those queries directly to LLM 308 without modification. However, as the users interact more with NLI system 400, user request modifier 306 may start detecting and extracting useful patterns that will then be stored in interaction registry 304. As a result, with future user requests, user request modifier 306 may be able to use the content of interaction registry 304 to adjust the user query to achieve the targeted answer faster.

More specifically, as shown, NLI system 400 may operate as follows:

(Step 1) A user submits a query via UI 412. UI 412 then communicates this query to both user request modifier 306 (step 1a) and to user interaction analyzer 302 (step 1b). User interaction analyzer 302 then performs any necessary pattern analysis based on prior user requests and updates user request modifier 306 if appropriate (step 1c).

(Step 2) User request modifier 306 consults interaction registry 304 for potential patterns that are related to the current user query. If a match is found, user request modifier 306 adjusts the user query, accordingly.

(Step 3) User request modifier 306 propagates the adjusted query to LLM 308.

(Step 4) LLM 308 returns an answer to user request modifier 306. Note that LLM 308 may interface with other software agents and data sources such as a database, documentation via systems such as Retrieval Augmented Generation (RAG), etc.

(Step 5) User request modifier 306 propagates the answer back to UI 412 for presentation back to the user.

For instance, assume that user 402 issues an initial query 404 that asks “Which radio has the highest power?” Without any existing chat interactions in interaction registry 304 towards this topic, user request modifier 306 may forward this query to LLM 308, which returns the answer 406 “Radio AP24J2 is using the most power.” However, this is not the information that user 402 was expecting. Thus, in turn, user 402 may issue a follow up query 408 of “Thanks but I meant transmit power?” This query may result in LLM 308 issuing an answer 410 of “Sorry for that! Radio AP24J2 has the highest transmit power.”

Here, user interaction analyzer 302 may store information regarding the interaction between user 402 and NLI system 400 in interaction registry 304. From a topic standpoint, user interaction analyzer 302 may tag this interaction information as being related to the task of reporting the power use of a radio in the wireless network. In addition, interaction registry 304 may indicate that query 408 was needed to add context to the interaction by equating the term “highest power” with “highest transmit power,” to optimize future interactions.

Now, assume that user 402 later issues query 416 that is identical to initial query 404. In turn, user request modifier 306 may match the pattern of query 416 to that of initial query 404 in interaction registry 304 and determine that user 414 actually meant to issue a query similar to that of query 408. In turn, user request modifier 306 may adjust query 416 to instead ask for the transmit power. This then causes LLM 308 to return answer 418 to user 414 via UI 412. Since this was the intended answer that user 414 was seeking, this interaction is better optimized than that of the interaction between user 402 and NLI system 400, where no adjustments were made to the queries.

In the context of the present techniques, it is contemplated any or all of the above approaches may be integrated within a single NLI system. This integration is feasible due to the complementary aspects of their respective advantages, thereby enhancing the overall functionality and utility of the NLI system. Fine-tuning the LLM may provide more pervasive improvements and generalization of the model to unseen user requests. For example, disambiguation of radio transmit power via fine-tuning from user interactions could automatically have a transfer of learning applied to endpoint transmit power. However, LLM fine-tuning is time consuming and so can only occur periodically, and moreover may not be possible for LLMs provided as a hosted service (e.g. OpenAI). Automatically modifying user requests is more continuous but the scope of disambiguation is constrained to semantically highly similar user questions. Modifying user requests might not always be possible in cases with significant residual ambiguity, whereby direct confirmation via users selecting adjusted proposed requests is required. However, user interaction should be minimized, ideally. In all of these cases, there is an implementational choice in the scope for user interaction learning. In one implementation, all user interactions could be processed globally, and large-scale crowdsourcing occurs to improve system performance for all users. In an alternative implementation, the learning can be personalized to individual users which could account for personal usage differences and preferences.

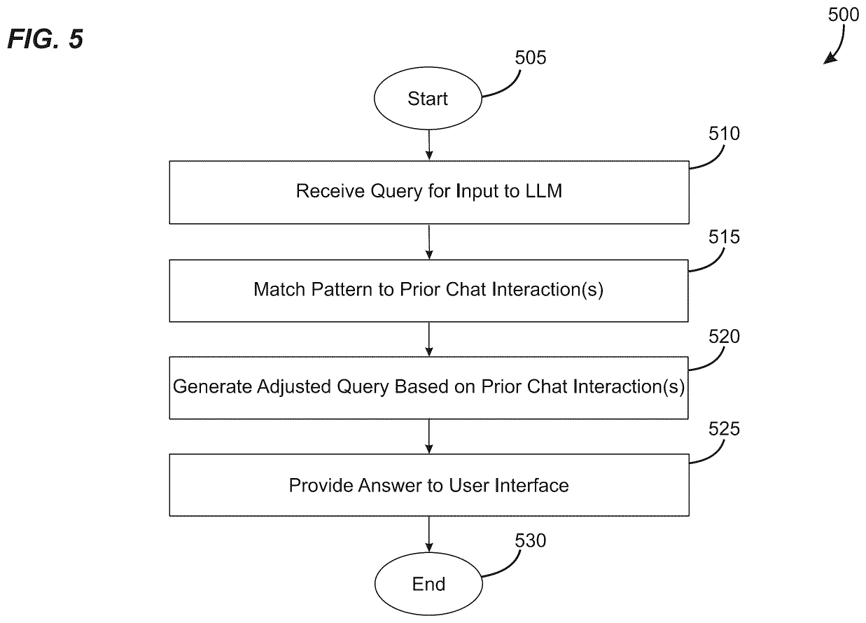

FIG. 5 illustrates an example simplified procedure 500 (e.g., a method) for using crowdsourced reinforcement learning to optimize inputs to an NLI system, in accordance with one or more implementations described herein. For example, a non-generic, specifically configured device (e.g., device 200), such as a router, firewall, controller for a network, endpoint, server, or the like, may perform procedure 500 by executing stored instructions (e.g., NLI process 248). The procedure 500 may start at step 505, and continues to step 510, where, as described in greater detail above, the device may receive a query from a user for input to a large language model. In some instances, the query requests information regarding a computer network. For instance, the query may request information regarding a particular networking entity in the computer network.

At step 515, as detailed above, the device may match a pattern associated with the query with one or more prior chat interactions between the large language model and one or more other users. In various implementations, the device may maintain an interactions registry that includes the one or more prior chat interactions. In some implementations, the one or more prior chat interactions include at least one follow up query to an answer provided by the large language model to the one or more other users.

At step 520, the device may generate an adjusted query based on the query and the one or more prior chat interactions, as described in greater detail above. In one implementation, the device generates the adjusted query based further in part on one or more prior chat interactions between the user and the large language model. In a further implementation, the device matches the query to the one or more prior chat interactions based on their semantic similarity. In yet another implementation, the device generates the adjusted query in part by merging the query with another query in the one or more prior chat interactions. In one implementation, the device generates the adjusted query based in part on a success metric associated with the one or more prior chat interactions. In some cases, the success metric is computed based on a count of follow up queries in the one or more prior chat interactions.a

At step 525, as detailed above, the device may provide an answer to the adjusted query from the large language model to the user.

Procedure 500 then ends at step 530.

While there have been shown and described illustrative implementations that provide for using crowdsourced reinforcement learning to optimize inputs to an NLI system, it is to be understood that various other adaptations and modifications may be made within the spirit and scope of the implementations herein. For example, while certain implementations are described herein with respect to using certain models for purposes of generating CLI commands, making API calls, charting a network, and the like, the models are not limited as such and may be used for other types of predictions, in other implementations. In addition, while certain protocols are shown, other suitable protocols may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method comprising:
receiving, at a device, a query from a user for input to a large language model;
matching, by the device, a pattern associated with the query with one or more prior chat interactions between the large language model and one or more other users;
generating, by the device, an adjusted query based on the query and the one or more prior chat interactions; and
providing, by the device, an answer to the adjusted query from the large language model to the user.

2. The method as in claim 1, wherein the one or more prior chat interactions include at least one follow up query to an answer provided by the large language model to the one or more other users.

3. The method as in claim 1, wherein the device generates the adjusted query based further in part on one or more prior chat interactions between the user and the large language model.

4. The method as in claim 1, wherein the device matches the query to the one or more prior chat interactions based on their semantic similarity.

5. The method as in claim 1, wherein the device generates the adjusted query in part by merging the query with another query in the one or more prior chat interactions.

6. The method as in claim 1, wherein the device generates the adjusted query based in part on a success metric associated with the one or more prior chat interactions.

7. The method as in claim 6, wherein the success metric is computed based on a count of follow up queries in the one or more prior chat interactions.

8. The method as in claim 1, further comprising:
maintaining, by the device, an interactions registry that includes the one or more prior chat interactions.

9. The method as in claim 1, wherein the query requests information regarding a computer network.

10. The method as in claim 9, wherein the query requests information regarding a particular networking entity in the computer network.

11. An apparatus, comprising:
one or more network interfaces;
a processor coupled to the one or more network interfaces and configured to execute one or more processes; and
a memory configured to store a process that is executable by the processor, the process when executed configured to:
receive a query from a user for input to a large language model;
match a pattern associated with the query with one or more prior chat interactions between the large language model and one or more other users;
generate an adjusted query based on the query and the one or more prior chat interactions; and
provide an answer to the adjusted query from the large language model to the user.

12. The apparatus as in claim 11, wherein the one or more prior chat interactions include at least one follow up query to an answer provided by the large language model to the one or more other users.

13. The apparatus as in claim 11, wherein the apparatus generates the adjusted query based further in part on one or more prior chat interactions between the user and the large language model.

14. The apparatus as in claim 11, wherein the apparatus matches the query to the one or more prior chat interactions based on their semantic similarity.

15. The apparatus as in claim 11, wherein the apparatus generates the adjusted query in part by merging the query with another query in the one or more prior chat interactions.

16. The apparatus as in claim 11, wherein the apparatus generates the adjusted query based in part on a success metric associated with the one or more prior chat interactions.

17. The apparatus as in claim 16, wherein the success metric is computed based on a count of follow up queries in the one or more prior chat interactions.

18. The apparatus as in claim 11, wherein the process when executed is further configured to:
maintain an interactions registry that includes the one or more prior chat interactions.

19. The apparatus as in claim 11, wherein the query requests information regarding a computer network.

20. A tangible, non-transitory, computer-readable medium storing program instructions that cause a device to execute a process comprising:
receiving, at the device, a query from a user for input to a large language model;
matching, by the device, a pattern associated with the query with one or more prior chat exchanges between the large language model and one or more other users;
generating, by the device, an adjusted query based on the query and the one or more prior chat exchanges; and
providing, by the device, an answer to the adjusted query from the large language model to the user.
